(19) United States
(12) Patent Application Publication
(10) Pub. No.: US 2014/0243179 A1
(43) Pub. Date: Aug. 28, 2014

(54) SECOND FOLD ROLLER WITH VARIABLE GAP CONTROL

(71) Applicant: GOSS INTERNATIONAL AMERICAS, INC., Durham, NH (US)

(72) Inventor: Charles A. Tomczak, Naperville, IL (US)

(73) Assignee: GOSS INTERNATIONAL AMERICAS, INC., Durham, NH (US)

(21) Appl. No.: 13/780,802

(22) Filed: Feb. 28, 2013

(51) Int. Cl. B31F 1/00

(52) U.S. Cl. CPC B31F 1/0009
USPC 493/442

(57) ABSTRACT

A second fold roller assembly is provided. The assembly includes a pair of second fold rollers, each supported on a support element, the pair of second fold rollers forming a nip therebetween for transporting a book, the pair of second fold rollers being separated by a gap at the nip. The assembly also includes one or more actuators coupled to the support elements and a controller coupled to the one or more actuators. The controller controls the one or more actuators to vary a size of the gap, wherein the size of the gap is controlled to be a first size when a leading edge of the book enters the nip and the size of the gap is controlled to be a second size after the leading edge of the book has exited the nip and while a portion of the book is in the nip, the second size being greater than the first size.

This application relates to a device for adjusting the gap between rollers of a second fold roller in a folder of a printing press.

### BACKGROUND INFORMATION

As described for example, in U.S. Pat. No. 6,279,890, incorporated herein by reference, in the field of web printing, a web of material is typically cut to form signatures, and the signatures are typically folded at least once to produce the desired configuration for the end product which may, for example, be a newspaper, periodical, or catalog. One of the known mechanisms for creating the fold is referred to as a rotary folder or couple, wherein a pair of second fold rollers are positioned proximate a folding cylinder with a gap or nip being provided between the second fold rollers. The web of material is wrapped around the folding cylinder and a folding blade is adapted to extend from the folding cylinder in a position corresponding to the nip. The folding blade is typically mounted to a spider assembly used to appropriately time the extension of the folding blade. When a folding blade extends from the folding cylinder, the folding blade extends into the nip, pushing the signature cut from the web into the nip. The second fold rollers, which rotate away from the folding cylinder, complete the fold in the signature initiated by the folding blade, and process the folded signature on to a delivery system including such things as delivery flies and conveyor belts.

U.S. Pat. No. 6,279,890, incorporated herein by reference, describes a printing press having a jaw mode assembly and a rotary mode assembly with a single folding cylinder adapted to feed either the jaw mode assembly or the rotary mode assembly is disclosed. A moving web of material is initially trained about the folding cylinder and cut into a signatures which are then temporarily held on the folding cylinder. A folding blade extends from the folding cylinder to initiate a fold in each signature and direct each signature to either the jaw mode assembly or the rotary mode assembly. The timing of the folding blade is coordinated and adjusted using an indexable spider assembly to feed either the jaw mode assembly or the rotary mode assembly. In the rotary mode, the second fold is imparted with a pair of second fold rollers located below the folding cylinder.

U.S. Pat. No. 5,937,757, incorporated herein by reference, describes a device for adjusting the gap size between folding rollers of a rotary press folding machine in order to permit automated setting of operating parameters while also facilitating the removal of paper jams. The device for adjusting the gap size between folding rollers of a rotary press folding machine includes a pair of counter-rotating folding rollers which define a folding nip or gap therebetween. Each folding roller is mounted to one end of a pivoting support arm, and a link arm is slidably and pivotably mounted to the other end. An extensible member connects the link arms to each other, which enables the distance between the rollers to be quickly and easily adjusted. An inflatable bag is disposed between the support arms which forces the rollers towards each other to resist spreading of the rollers when a paper passes through the gap between the rollers. The bag can be quickly deflated from a remote location to allow removal of jammed papers, and can be quickly re-inflated to the desired setting to minimize down time. A control system controlling both the extensible member and the inflatable bag permits rapid adjustment of the folding machine to accommodate changes in paper thickness.

U.S. Pat. No. 5,964,154, incorporated herein by reference, purports to describe a device for accurately setting a roller gap of a folding device of a rotary web-fed press uses a rotatable threaded spindle with contrarotating threads at both of its ends. A drivable differential screw gear mechanism is associated with each threaded spindle end and operates to pivot two-armed levers that support the folding rollers to thus vary the roller gap.

U.S. Pat. No. 5,147,276, incorporated herein by reference, purports to describe a longitudinal folding device for folding symmetrical and asymmetrical paper products has a folding blade and cooperating folding rollers whose positions with respect to each other can be varied. The folding blade or the folding roller pair can be shifted laterally with respect to a longitudinal fold line. In addition, the spacing between the folding rollers can be adjusted in accordance with paper thickness and number of sheets in the product to be folded.

U.S. Pat. No. 3,954,258 describes a second fold roller mounting and adjustment assembly. The second fold roller assembly of the folder includes adjustable stop members associated with the fold roller support levers for regulating and maintaining a predetermined space between the rollers in their operative position. Spring members are provided to bias the support levers against the stop members and these spring members are mounted on the stop members so that when space adjustments of the rollers are effected, the stop members, the support levers and the spring members move in unison as an integral unit and the preset tension of the spring members remains constant throughout all positions of adjustment

### BRIEF SUMMARY OF THE INVENTION

In accordance with a first embodiment of the present invention, a second fold roller assembly is provided. The assembly includes a pair of second fold rollers, each supported on a support element, the pair of second fold rollers forming a nip therebetween for transporting a book, the pair of second fold rollers being separated by a gap at the nip. The assembly also includes one or more actuators coupled to the support elements and a controller coupled to the one or more actuators. The controller controls the one or more actuators to vary a size of the gap, wherein the size of the gap is controlled to be a first size when a leading edge of the book enters the nip and the size of the gap is controlled to be a second size after the leading edge of the book has exited the nip and while a portion of the book is in the nip, the second size being greater than the first size.

The aforementioned embodiment may also include other optional components and features. For example, the assembly may further include a sensor for detecting a position of a folding blade, the controller coupled to the sensor, the controller controlling the size of the gap as a function of the position.

In accordance with other optional aspects of the first embodiment, the assembly may further include a first bias assembly coupled to the support element of a first of the pair of second fold rollers, and a second bias assembly coupled the support element of a second of the pair second fold rollers, wherein the gap is the first size when the first and second bias assemblies are extended. The one or more actuators may include a first actuator coupled to the first bias assembly and a second actuator coupled to the second bias assembly, and the controller may control the first and second actuators to retract the first and second bias assemblies to change the size of the gap to the second size. In the regard, the first and second bias assemblies may, for example, be pneumatic piston rod cylinders. Alternatively, the first and second bias assemblies each may comprise a connecting rod and a pneumatic cylinder, or alternatively, a connecting rod and a spring.

In accordance with other optional aspects of the first embodiment, the first and second actuators may, for example, be hydraulic piston rod cylinders. Further, if provided in combination with the first and second bias assemblies, the hydraulic piston rod cylinders each may be connected to a connecting rod of the first and second bias assemblies, or if the bias assemblies are pneumatic piston rod cylinders, to the piston rods.

In accordance with other optional aspects of the first embodiment, each support element may have a first end and a second end, the first end supporting one of the second fold rollers, and the second end connected to an associated one of the first and second bias assemblies. Further, each support element may be rotatable about a respective pivot located between the first end and the second end.

In accordance with a second embodiment of the present invention, a method of varying a gap between second fold rollers of a folder as a book passes through the gap is provided. The method includes the steps of: providing a pair of second fold rollers, each supported on a support element, the pair of second fold rollers forming a nip therebetween for transporting a book, the pair of second fold rollers being separated by a gap at the nip; rotating the pair of second fold rollers; setting the gap at a first size; inserting a leading edge of a book into the nip between the rotating pair of second fold rollers while the gap is at the first size; and changing the gap to a second size after the leading edge of the book has exited the nip between the rotating pair of second fold rollers and while a portion of the book is in the nip between the rotating pair of second fold rollers, the second size being greater than the first size.

The aforementioned second embodiment may also include other optional components and features. For example, the method may further include detecting a position of a folding blade and changing the size of the gap as a function of the position. The method may, for example, include the steps of providing a first bias assembly coupled to the support element of a first of the pair of second fold rollers; providing a second bias assembly coupled to the support element of a second of the pair second fold rollers, wherein the gap is the first size when the first and second bias assemblies are extended; and wherein the step of changing further includes retracting the first and second bias assemblies to change the size of the gap to the second size.

### BRIEF DESCRIPTION OF THE DRAWINGS

The present invention will be further described with respect to the following Figures, in which:

FIG. 1 illustrates a second fold roller assembly in accordance with an embodiment of the present invention.

FIG. 2 shows an exemplary implementation of the second fold roller assembly of FIG. 1.

FIGS. 3A and 3B shows the pneumatic cylinder assembly of FIG. 2 in further detail.

FIG. 3C illustrates an exemplary manner of connecting the connecting rod of FIG. 3A to the microhydraulic cylinder of FIG. 3A

FIGS. 3D and 3E show alternative arrangements for the connecting rod.

FIG. 3F shows an alternative connecting rod bias assembly comprised of a pneumatic piston.

### DETAILED DESCRIPTION OF PREFERRED EMBODIMENTS OF THE INVENTION

As one of ordinary skill in the art will appreciate, a second fold roller assembly is typically employed downstream of a folding cylinder of a rotary folder of a printing press. Each printed product on the folding cylinder, upon reaching a predetermined angular position on the folding cylinder, is severed from the ensuing web by a cutting cylinder, and a folding blade of the folding cylinder tucks the product into a nip formed by a pair of second fold rollers. In this regard, the product is typically a set of folded sheets (or signatures) which is generally referred to as a book, or in the example of newspaper production, a section of the newspaper.

When the book receives the second fold via the second fold rollers, the second fold rollers may impart marking onto the outside pages of the book due to residual ink on the second fold rollers. This marking, often called “set-off” in the printing industry, is highly undesirable. Set-off can also occur on inside pages of the book where ink from one inside page marks the page it faces. In both types of set-off, the amount of marking created is a function of the pressure applied by the second fold rollers to the book. Pressure is not the only factor, for example, ink density also affects marking. However, in general, greater pressure results in more marking, and less pressure results in less marking.

It is known in the art to have the press operator mechanically open the gap between the second fold rollers thereby lessening the nip pressure and reducing marking. However, this reduced pressure can also cause a loss of performance in the delivery of the books through the rollers, causing the books to be delivered in a disorderly fashion to downstream belts. This, in turn, may cause downstream conveyor grippers to drop the books, and/or to mark the books due to misregistration of the books in the grippers.

In accordance with an embodiment of the present invention, the nip pressure between the second fold rollers is dynamically controlled as the book passes through the nip. In particular, the nip pressure is greatest when the second fold rollers initially contact the book, and the nip pressure is thereafter reduced by increasing the gap between the second fold rollers as the remainder of the book passes through the nip. This process is then repeated for the next book entering the nip. In this regard, it is the initial contact of the nip with the leading edge of the book that is most critical in ensuring a proper positioning of the book as it passes through the nip in order to effect a correct release of the book to downstream processing by, for example, a delivery fan or conveyor. After this initial gripping of the book by the second fold roller nip, the pressure on the book is lessened by increasing the gap between the two fold rollers, therefore decreasing the occurrence of marking on the book. This dynamic control of nip pressure can be implemented by synchronizing the control of nip pressure with the position of the folding blade which inserts the book into the entrance of the second fold roller nip. This synchronization can be implemented electronically or mechanically as explained below.

Another advantage of this embodiment is that it can eliminate the need to use special rollers for tabloid production. These special rollers, called tabloid rollers, rollers are undercut in the printed area of the roller so that, in the center, it has only a working surface of about 1″ in the circumferential direction (called the “crushing strip”). On each side of the paper, in the non-print area, each tabloid roller in a pair has a pair of ⅜″ wide fully circumferential surfaces forming a pair of side nips between the rollers. The rotation of the tabloid rollers is timed so that as the leading edge of a signature reaches tabloid roller pair, the crushing strips meet to form a nip to grip the signature. Once the leading edge passes the crushing strips, the signature is gripped only by the side nips. Since the leading edge of the signature is not printed, this eliminates pressure on the printed area thus preventing marking on the front page and inner pages. However, tabloid rollers are undesirable for a number of reasons. For example, due to the above-referenced positioning of the crushing strip and side strips, tabloid rollers are web width dependent. This problem is exponentially compounded when considering multi-web presses (i.e. presses that print in a number of widths). Tabloid rollers are also more difficult to manufacture than conventional rollers. Further, with tabloid rollers, the web can wander during production, and the grip on the paper can be haphazard leading to delivery problems.

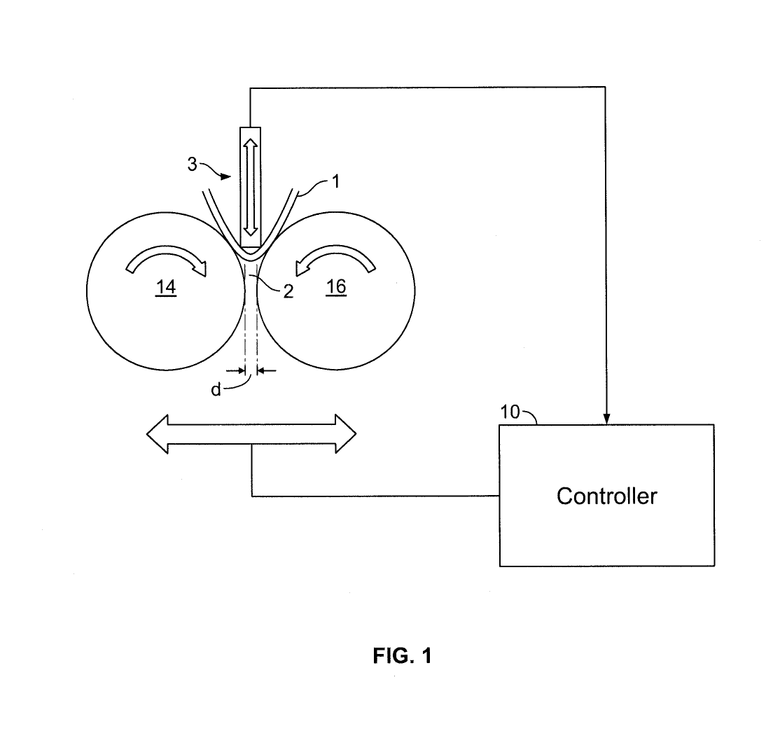

FIG. 1 schematically illustrates a pair of second fold rollers 12, 14 and a folding blade 3. Second fold rollers 12, 14 are driven rollers which receive a book 1, newspaper section or set of signatures (hereinafter “book”) at a nip 2 formed between rollers 12, 14. The book is inserted into the nip 2 by a folding blade 3 which extends to place the book 1 into the nip and then retracts to allow the book to pass through the nip. This process is then repeated for each book. The rotational movement of the driven rollers 12, 14 and the movement of the folding blade 3 can be implemented in any known manner and thus will not be described herein.

In accordance with the embodiments of the present invention, a controller 10 is provided which controls a gap or distance “d” between second fold rollers 14, 16. Controller 10 varies the gap or distance “d” as each book 1 passes through the nip to vary the pressure applied to the book. Controller 10 controls the gap “d” between rollers 14, 16 through one or more actuators, such as motor(s), solenoid(s), or pistons. The rollers are supported for movement relative to each other by the actuator(s) through one or more support elements, such as rotatable arm(s), translatable carriage(s), eccentric bearing(s), or other movable element(s). Controller 10 is an electronic controller which may be implemented as software executing on a computer, may be implemented entirely in hardware (as for example, an ASIC, FPGA, or other circuitry not employing software), or may be implemented as a combination of software and hardware.

Controller 10 controls the relative position between rollers 14 and 16 to maintain a gap “d” of a first size as the rollers 14, 16 secure a leading edge of the book 1 in a nip 2 formed between rollers 14, 16. After the leading edge of the book is secured in the nip, the controller controls the rollers 14, 16 to increase the gap “d” to a second size, greater than a first size, as the book passes thought the nip. The controller then controls the roller to maintain a gap of the first size as the next book enters the nip, and the process repeats. In FIG. 1, the rollers 14, 16 are illustrated as separated by a gap “d” of the first size since the leading edge of the book is just entering the nip. It will also be appreciated that the size of the gap could increase according to a variety of functions between the first and second gap sizes, including, for example a square wave function, a sinusoidal function, or any other desired function. Controller 10 synchronizes the change in gap size to the movement of the folding blade 3. In this regard, when the folding blade 3 is fully extended, the leading edge of the book is inserted into the nip. The position of the folding blade 3 can be monitored by the controller in a variety of ways, including, for example, a sensor such as an encoder or resolver on the motor shaft driving the folding blade, an encoder or resolver on a gear in a gear train between the motor and the folding blade, or by directly sensing a position of the folding blade, for example, with an optical sensor and target.

The timing of the gap change, as well as the magnitude of the change in gap size can be controlled via the controller 10. For example, it may be desirable to have a larger change in gap size for a 120 page signature than or a four page signature. As to the timing of the gap change, the gap size is preferably increased after the leading edge of the signature has exited the nip but at or before about 1 inch of the signature has exited the nip, preferably at or before ⅝ inch of the signature has exited the nip. Most preferably, the gap size is increased when about ½ inch of the signature has exited the nip.

Although FIG. 1 illustrates controller 10 as an electronic controller, it should be appreciated that gap control could be implemented in an entirely mechanical manner as well. For example, synchronization of the change in gap “d” with the position of a folding blade could be implemented with a cam and cam follower coupled to the support element(s) via a linkage arrangement.

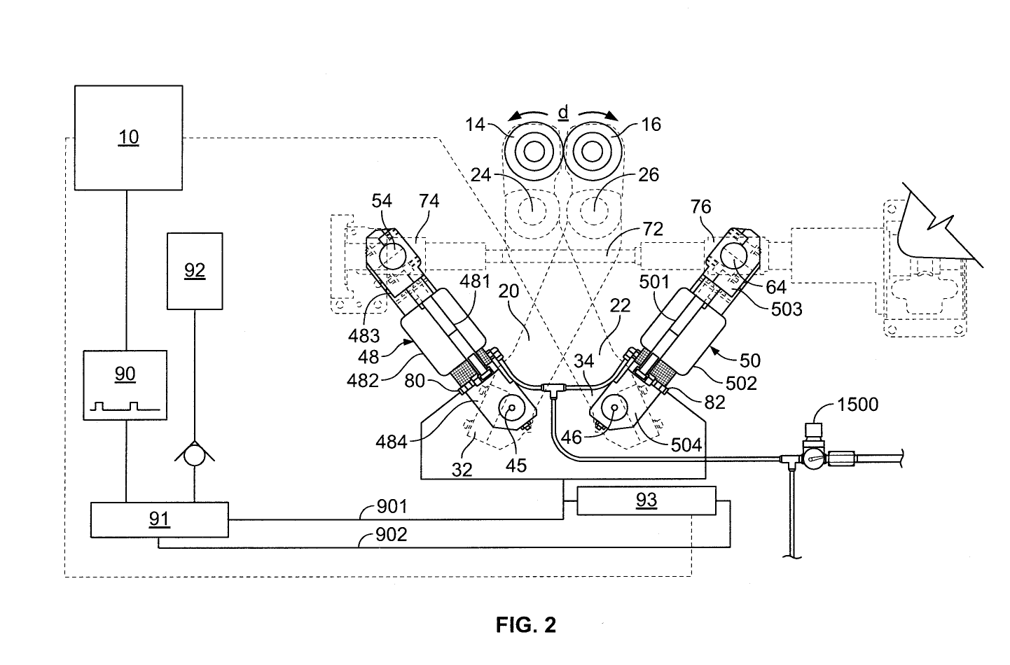

FIG. 2 shows an exemplary arrangement for controlling the size of the gap between rollers 14, 16. The folding blade 3 has been omitted for ease of illustration. This design is implemented as a modification of the second fold roller design described in U.S. Pat. No. 5,937,757. Roller 14 is mounted on support arm 22, and pivotable about fixed shaft axis 24. Roller 16 is mounted on support arm 20, and pivotable about fixed shaft axis 26. A distal end 32 of support arm 20 is connected to connecting rod bias assembly 48 at pivot pin 45, and distal end 34 of support arm 22 is connected to connecting rod bias assembly 50 at a pivot pin 46. A gap between the rollers 14, 16 increases as the assemblies 48, 50 retract, and decreases as the assemblies 48, 50 extend.

The set (minimum) gap between the rollers 14, 16 is set by the position of the screw 72 and supports 74, 76. First end block 483 is secured to support 74 at pivot pin 54, and first support block 503 is secured to support 76 at pivot pin 64. Movement of the screw 72 causes the pivot pins 64, 54 to become closer or farther apart. Connecting rods 481, 501 are fixed to first block 483, 503 and are slidingly engaged to second block 484, 504, respectively, as described in further detail below. Bias assemblies 48, 50 include pneumatic cylinders 482, 502 and connecting rods 481, 501. The pneumatic cylinders 482, 502 will bias the connecting rods 481, 501 to full extension, causing the rollers 14, 16 to be separated by a minimum gap which is set as a function of the distance between pivot pins 54, 64, which in turn, is set by the screw 72. The screw position can be set manually, or if desired via the controller 10 (dashed lines).

The pneumatic cylinders 482, 502 act as a safety feature to prevent equipment damage in the event there is a jam in the second fold roller, in similar manner as described in U.S. Pat. No. 5,937,757. In the event of a jam, a number of consecutive sections of papers may become stuck between the folding rollers 14, 16. As the jam accumulates, the rollers 14, 16 are forced apart, overcoming the pneumatic pressure of the cylinders 482, 502 and causing them to retract. In this regard, the pneumatic cylinders 482, 502 keep the rod 481, 501 (which permits center 45 to slide toward center 54) at its greatest length. As the cylinder 482, 502 retracts (either due to force from a jam or by pressure release), the rod becomes effectively shorter allowing the distance from center 54 to center 45 to decrease. Accordingly, the support arm 20 can rotate clockwise about center 24. If you apply the same operation to the opposite side, the gap opens due to the effective shortening of the rods 481, 501. An added feature of the pneumatic cylinders, in the event of a folder jam is that the pressure can be easily released via the pressure gauge 1500 thereby allowing for a quick clearance of a jam because the gap will increase to a pre-set maximum. The use of pneumatic cylinders in this manner to react to a jam is known in the art and will not be described in further detail herein.

In accordance with an embodiment of the present invention, a hydraulic actuator 80, 82 is coupled to each rod 481, 501. The hydraulic actuators 80, 82 are controlled by the controller 10 to force rods 481,501 to overcome the bias of the cylinders 482, 502 and retract and thereby increase the gap size. An advantage of this arrangement is that in the event of a failure of the cylinders 482, 502 or of controller 10, the second fold rollers will continue to operate at the minimum gap using the prior art pneumatic cylinder architecture.

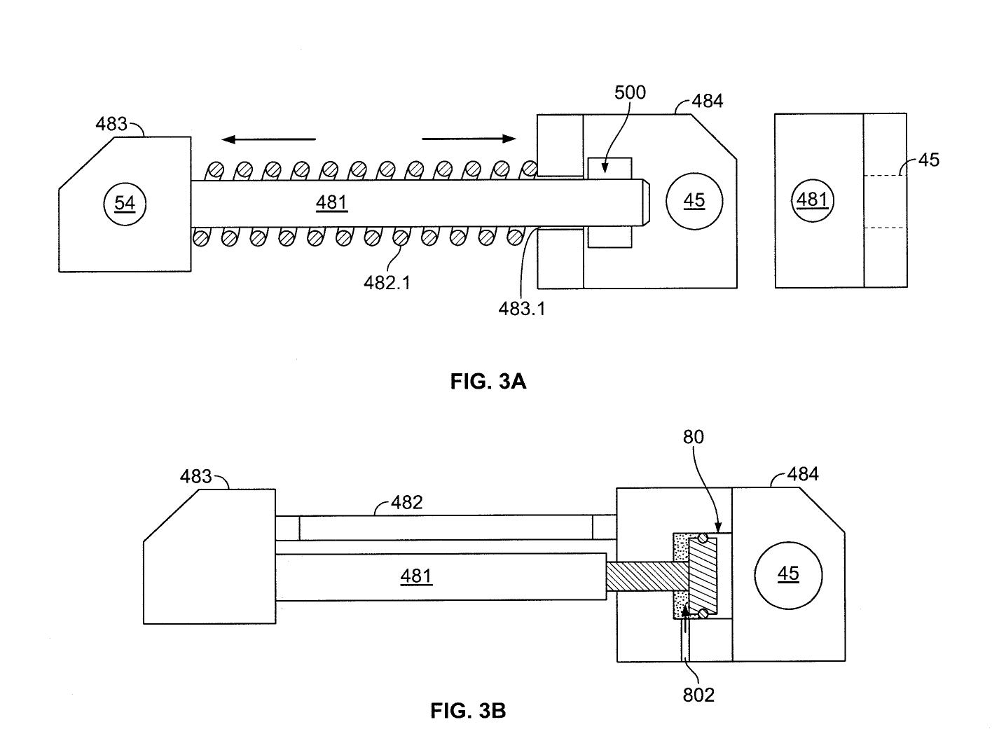

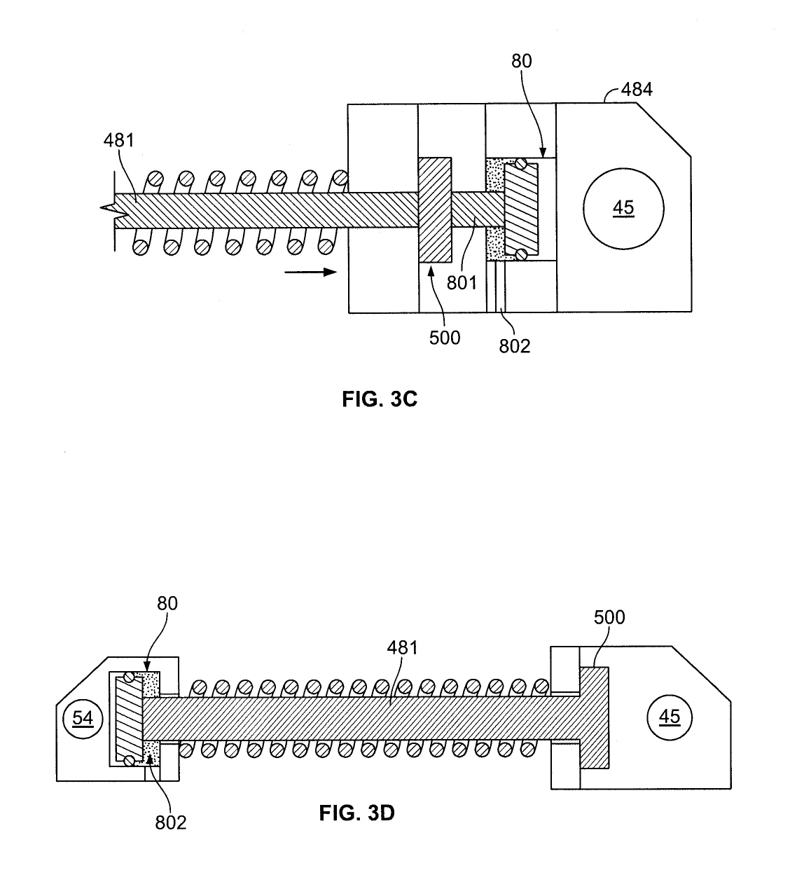

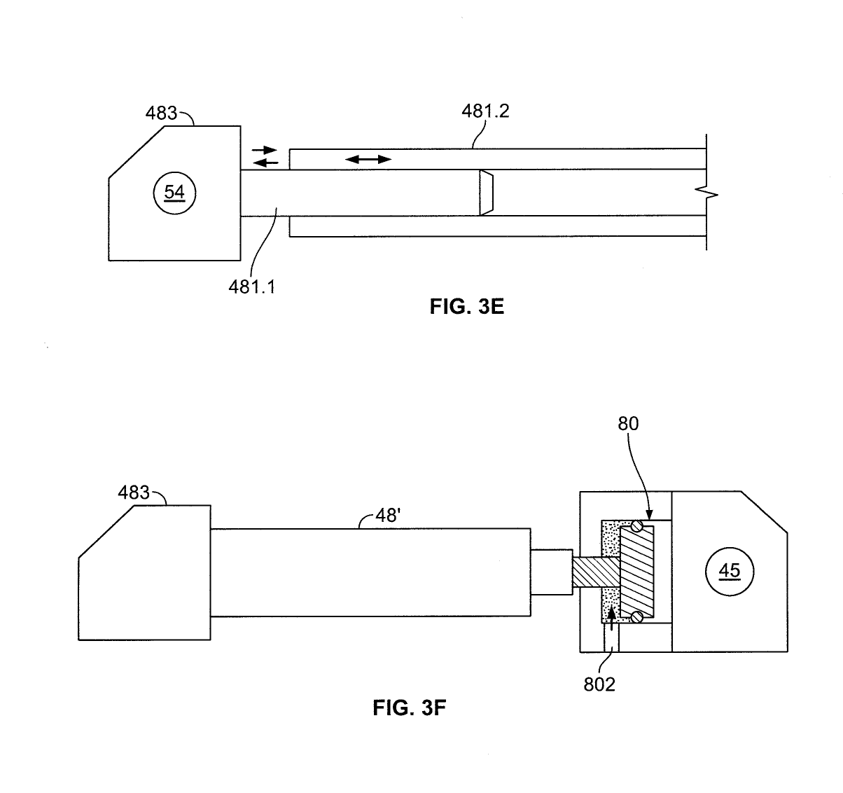

As illustrated in FIG. 2, controller 10 provides a valve control signal 90 (illustrated as a square wave) to the solenoid valve 91. Solenoid valve 91 is connected to hydraulic actuators 80,82 and variable volume accumulator 92 via line 901. Solenoid valve 91 interacts with accumulator 92 and variable volume accumulator 93 to extend and retract the pistons of the hydraulic actuators 80, 82 according to the valve control signal 90. Line 902 is the return line from accumulator 93. In this regard, the hydraulic actuators 80, 82 are illustrated as “micro” hydraulic cylinders, each having a piston which is pinned to the rod 481, 501, as shown in further detail in FIGS. 3B-C. These hydraulic actuators 80, 82 are able to impart sufficient force to overcome the pressure applied by the pneumatic cylinders and cause the pneumatic cylinders to retract, thereby increasing the gap “d”. The amplitude of the cylinder movement of the hydraulic cylinder can be varied by varying the volume in the variable volume accumulator. If desired, this can be adjusted manually, or via the controller 10 (dashed lines).

FIGS. 3A-C show a connecting rod bias assembly 48 in further detail. Connecting rod bias assembly 50 may have the same structure.

FIG. 3A illustrates the assembly 48 as it would appear on an existing system prior to being modified by variable gap control, and as such, the hydraulic actuator 80 is omitted. In FIG. 3A, a spring 482.1 is shown for providing a bias force for the rod 481. However, spring 482.1 of FIG. 3A can be replaced with the pneumatic cylinder 482 of FIGS. 2 and FIG. 3B, and vice versa. Accordingly, it should be understood that in each of FIGS. 2, 3A-E, the pneumatic cylinder 482 can be replaced with a spring 482.1.

FIG. 3B shows the assembly 48 of FIG. 2 with the hydraulic actuator 80 and FIG. 3C shows the manner in which the hydraulic actuator 80 is secured to the rod 481 in further detail. Referring to FIGS. 3A and B, assembly 48 includes a connecting rod 481, a pneumatic cylinder 482 (or spring 482.1), a first end block 483 and a second end block 484. Each block 483 has a bore 483.1 into which the rod 481 can freely slide until limited by stop 500 secured to the end of rod 481. The connecting rod 481 is secured or pinned to the second block 483. The opposing ends of the pneumatic cylinder 482 (or spring 482.1) are secured to the first 484 and second 483 blocks respectively. The pneumatic cylinder 482 biases the rod towards extension by exerting a force against the first and second blocks, thereby providing the set gap.

Referring to FIGS. 3B and 3C, piston 801 of hydraulic acutuator 80 is secured or pinned to the rod 481 at stop 500. As noted above, the pneumatic cylinder 482 applies a bias force against the blocks 483, 484. The addition of sufficient hydraulic pressure through input 802 to exceed the bias force causes the piston to move toward first block 484, resulting in first block 484 moving towards second block 483 and increasing the gap size “d”. As the hydraulic pressure is reduced, this will cause the piston 801 to move away from the first block 484, resulting in first block 484 moving away from the second block 483 and decreasing the gap size “d” until it returns to the set minimum gap.

The hydraulic actuator 80 is controlled by a solenoid 91 which pressurizes the actuator 80 causing the piston 801 in the actuator to move which, in turn, creates a force upon block 484 moving it toward center 54. In this regard, rod 481 slides through the bore 483.1 in first block 484. With the arrangement shown, the signal from 90 to 91 can be adjusted to suit the amplitude and duration of the gap variability desired. The variable volume accumulator 93 is used to set the amplitude of the force. Variable volume accumulator 93 controls the volume of the hydraulic fluid in the line by diverting some of the fluid accumulator 92.

The embodiment of FIG. 2 has the further advantage in that it can be used as a retrofit to upgrade existing second fold rollers that employ either a pneumatic cylinder or spring. In this regard, existing second fold rollers include rollers 14, 16, support arms 20, 22, lead screw 72, rods 581, 501 and pneumatic cylinders 482, 502 (or springs). To retrofit such a mechanism, a micro hydraulic piston 80, 82 is provided in rod block 484, 504, and is secured to the existing rod 481, 501 at stops 500. The microhydraulic piston is then connected to a controller 10 to dynamically change the gap as described above.

In each of the embodiments described above, it should be appreciated that the pneumatic cylinders 482, 502 may be replaced with springs which would operate similarly to bias the assemblies 48, 50 to extend to the set (minimum gap). Further, the separate pneumatic cylinder (482, 502) and rods (481, 501) could be replaced by a single pneumatic piston cylinder as illustrated in FIG. 3F. In such an embodiment the hydraulic actuators 80, 82 would be secured to the piston of the pneumatic piston cylinders.

Although micro hydraulic cylinders are illustrated in FIG. 2 for overcoming the pressure applied by the cylinders 48, 50, and this is advantageous, it will be appreciated that alternative mechanisms known in the art can be used to overcome the pressure applied by the bias assemblies 48, 50 and cause them to retract. Similarly, although springs, pneumatic cylinders, and pneumatic piston cylinders are advantageous, alternative types of bias assemblies can be used to apply the bias force to reach the minimum gap.

FIG. 3D shows an alternative arrangement in which the hydraulic actuator 80 (or 82) pinned to connecting rod 481 (or 501) is located in bock 483 (or 503). The other end of the connecting rod 481 (or 501) terminates in stop 500, and is slidable within block 484 (or 504) via a clearance hole or bushing. If a jam condition were to occur, the spring (or alternatively, a pneumatic cylinder) would compress as block 45 is moved towards block 54. The hydraulic actuator 80 (or 82) would not be affected.

FIG. 3E shows an embodiment wherein the rod 481 (or 501) is a two part telescopic rod, with the inner rod 481.1 secured or pinned to one block (illustrated in reference to block 483) and the outer sleeve 481.2 secured to the other block, and the hydraulic piston pinned or secured to the inner rod 481.1.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A second fold roller assembly, comprising:
a pair of second fold rollers, each supported on a support element, the pair of second fold rollers forming a nip therebetween for transporting a book, the pair of second fold rollers being separated by a gap at the nip;
one or more actuators coupled to the support elements; and
a controller coupled to the one or more actuators, the controller controlling the one or more actuators to vary a size of the gap, wherein the size of the gap is controlled to be a first size when a leading edge of the book enters the nip and the size of the gap is controlled to be a second size after the leading edge of the book has exited the nip and while a portion of the book is in the nip, the second size being greater than the first size.

2. The assembly of claim 1, further comprising a sensor for detecting a position of a folding blade, the controller coupled to the sensor, the controller controlling the size of the gap as a function of the position.

3. The assembly of claim 1, further comprising:
a first bias assembly coupled to the support element of a first of the pair of second fold rollers;
a second bias assembly coupled the support element of a second of the pair second fold rollers, wherein the gap is the first size when the first and second bias assemblies are extended;
wherein the one or more actuators include a first actuator coupled to the first bias assembly and a second actuator coupled to the second bias assembly, and wherein the controller controls the first and second actuators to retract the first and second bias assemblies to change the size of the gap to the second size.

4. The assembly of claim 1, wherein the first and second actuators are hydraulic piston rod cylinders.

5. The assembly of claim 3, wherein the first and second bias assemblies are pneumatic piston rod cylinders.

6. The assembly of claim 3, wherein the first and second bias assemblies each include a connecting rod and either a spring or a pneumatic cylinder.

7. The assembly of claim 3, wherein each support element has a first end and a second end, the first end supporting one of the second fold rollers, and the second end connected to an associated one of the bias assemblies.

8. The assembly of claim 7, wherein each support element is rotatable about a respective pivot located between the first end and the second end.

9. The assembly of claim 1, wherein the controller changes the gap from the first size to the second size after the signature has entered the nip and before one inch of a leading edge of the signature has exited the nip.

10. A method of varying a gap between second fold rollers of a folder as a book passes through the gap, comprising:
providing a pair of second fold rollers, each supported on a support element, the pair of second fold rollers forming a nip therebetween for transporting a book, the pair of second fold rollers being separated by a gap at the nip;
rotating the pair of second fold rollers;
setting the gap at a first size;
inserting a leading edge of a book into the nip between the rotating pair of second fold rollers while the gap is at the first size;
changing the gap to a second size after the leading edge of the book has exited the nip between the rotating pair of second fold rollers and while a portion of the book is in the nip between the rotating pair of second fold rollers, the second size being greater than the first size.

11. The method of claim 10, further comprising detecting a position of a folding blade and changing the size of the gap as a function of the position.

12. The method of claim 10, further comprising
providing a first bias assembly coupled to the support element of a first of the pair of second fold rollers;
providing a second bias assembly coupled to the support element of a second of the pair second fold rollers, wherein the gap is the first size when the first and second bias assemblies are extended; and
wherein the step of changing further includes retracting the first and second bias assemblies to change the size of the gap to the second size.

13. The method of claim 9, wherein the step of changing comprises changing the gap from the first size to the second size after the signature has entered the nip and before one inch of a leading edge of the signature has exited the nip.

14. The method of claim 12, wherein the first and second bias assemblies are pneumatic piston rod cylinders.

15. The method of claim 12, wherein the first and second bias assemblies each include a connecting rod and either a spring or a pneumatic cylinder.
